(19) United States
(12) Patent Application Publication
(10) Pub. No.: US 2002/0011050 A1
(43) Pub. Date: Jan. 31, 2002

(54) Suction cleaner with cyclonic dirt separation

(76) Inventors: Samuel N. Hansen, Jenison, MI (US); Gary L. Smith, Belding, MI (US); Eric R. Metzger, Sand Lake, MI (US); David E. McDowell, Grand Rapids, MI (US); Brandon L. Mouw, Wyoming, MI (US)

Correspondence Address: MCGARRY BAIR LLP, 171 MONROE AVENUE, SUITE 600, GRAND RAPIDS, MI, 49503, US

(21) Appl. No.: 09/849,143

(22) Filed: May 4, 2001

Related U.S. Application Data
(60) Provisional application No. 60/201,933, filed on May 5, 2000.
(60) Provisional application No. 60/269,044, filed on Feb. 15, 2001.

(51) Int. Cl. B01D 50/00

(52) U.S. Cl. 55/337

(57) ABSTRACT

The invention relates to cyclonic dirt separator comprising a dirt-collection assembly including a dirt tank having an inlet aperture and an outlet aperture, a cyclonic separator, at least one filter element, and a suction source fluidly connected with the dirt collection assembly. In one embodiment, the cyclonic dirt separator includes a separator plate cooperating with the housing to form a toroidal region of the dirt tank for aiding in the separation of dirt from a suction airstream developed by the suction source. The separator plate has an outer diameter smaller than the inner diameter of the dirt tank, creating a gap between the outer edge of the separator plate and the inner wall of the dirt tank. A further embodiment includes dual cyclonic separators fluidly connected through a filter assembly. A further embodiment includes a cyclonic separator in the form of a tangential helical ramp.

### RELATED APPLICATIONS

This application claims the benefit of U.S. Provisional Application 60/201,933, filed May 5, 2000 and U.S. Provisional Application 60/269,044, filed Feb. 15, 2001, all of which are incorporated herein in their entirety.

### BACKGROUND OF THE INVENTION

1. Field of the Invention

The invention relates to suction cleaners, and in particular to a separator for a suction cleaner. In one of its aspects, the invention relates to a separator with a cyclonic airflow path to separate dirt and debris from air drawn into the cleaner. In another of its aspects, the invention relates to a separator that deposits the dirt and debris in a collection receptacle. In another of its aspects, the invention relates to a separator including a supplementary fine particle filter.

2. Description of the Related Art

Dirt separators for suction cleaners, using cyclonic action for separation of dirt from the airflow, are known. U.S. Pat. No. 4,944,780, issued Jul. 31, 1990, to Usmani, discloses a central vacuum system having a cylindrical dirt tank with an interior cylindrical wall adjacent to a tangential inlet. Dirt-laden air drawn into the tangential inlet circulates about the interior of the cylindrical tank to the outside of the interior cylindrical wall. Entrained particulates are separated from the airstream and drop to the bottom of the cylindrical dirt tank. Exhaust air, which may carry smaller particulates, is drawn through a pleated cylindrical filter that is carried on a spindle inside the interior cylindrical wall. Waste air that passes through the filter is drawn through an exhaust opening and is exhausted from the central vacuum cleaner through an exhaust outlet. U.S. Pat. No. 2,943,698, issued Jul. 5, 1968, to Bishop discloses a cylindrical dirt tank having a tangential air inlet, an interior frusto-conical shield, and a cylindrical filter element held in place by a frame comprising a cylindrical wire mesh or perforate screen. After dirt-laden air is introduced into the tank through the inlet, heavier dirt particles fall into a bottom portion of the dirt tank while waste air and any fine particles left in the waste air are exhausted through an air exhaust outlet. The filter element is interposed between the dirt tank and the air exhaust outlet to filter fine particles from the exhaust air.

### SUMMARY OF THE INVENTION

According to the invention, a vacuum cleaner comprises a housing defining a cyclonic airflow chamber for separating contaminants from a dirt-containing airstream, and a cyclonic chamber inlet and an airstream outlet in fluid communication with the cyclonic airflow chamber. A nozzle base includes a main suction opening fluidly connected with the cyclonic chamber inlet. An airstream suction source is fluidly connected to the main suction opening and to the cyclonic airflow chamber inlet for drawing dirt-containing air from the main suction opening and passing the dirt-containing air to the cyclonic airflow chamber, and selectively establishes and maintains a dirt-containing airstream from the main suction opening to the dirt-containing airstream inlet. A main filter assembly includes a filter element positioned centrally within the cyclonic airflow chamber for filtering residual contaminants from the dirt-containing airstream prior to exit of the airstream from the cyclonic airflow chamber. A dirt-collecting bin is beneath the main filter assembly within the housing, and a separator plate between the filter element and the dirt-collecting bin forms a toroidal chamber within the housing and separates the toroidal chamber from a dirt-collecting chamber.

In a preferred embodiment, the separator plate is mounted to a lower portion of the filter element and extends radially from the filter element toward the housing. The separator plate forms a gap with the housing for passage of dirt particles from the toroidal chamber to the dirt-collecting bin. The gap between the separator plate and the housing is annular, the separator plate being circular and the housing having a circular wall adjacent the separator plate.

In a preferred embodiment, the cyclonic chamber inlet is in the toroidal chamber.

In a further embodiment, the airstream outlet is in an upper central portion of the housing.

In a further embodiment, a secondary filter positioned between the filter element and the airstream outlet.

In a further embodiment, the secondary filter comprises a fine mesh.

In a further embodiment, the airstream outlet is in a lower portion of the housing.

In a further embodiment, the relative cross-sectional area of the separator plate with respect to the housing is in the range of 0.75 to 0.95.

In a further embodiment, the relative cross-sectional area of the separator plate with respect to the housing is in the range of 0.8 to 0.92.

In a further embodiment, the relative cross-sectional area of the separator plate with respect to the housing is about 0.9.

In a further embodiment according to the invention, a vacuum cleaner comprises a housing defining a first cyclonic airflow chamber for separating contaminants from a dirt-containing airstream, said housing further comprising an airstream inlet and an airstream outlet in fluid communication with said first cyclonic airflow chamber, a nozzle base including a main suction opening fluidly connected with said first cyclonic airflow chamber inlet, and an airstream suction source fluidly connected to the main suction opening and to the first cyclonic airflow chamber inlet for drawing the dirt-containing airstream from the main suction opening and passing the dirt-containing airstream to the first cyclonic airflow chamber. The suction source selectively establishes and maintains the dirt-containing airstream from the main suction opening to said first cyclonic airflow chamber. A second cyclonic airflow chamber is formed coaxially with the first cyclonic airflow chamber. A main filter assembly including a filter element is positioned between the first and second cyclonic airflow chambers for filtering residual contaminants from the dirt-containing airstream prior to exit of the airstream from the first cyclonic airflow chamber. A first dirt-collecting bin is beneath the first cyclonic airflow chamber and a second dirt-collecting bin in communication with the second cyclonic air flow chamber is positioned axially of the first dirt-collecting bin.

In a further embodiment, a frusto-conical wall defines the second cyclonic airflow chamber and a wall of the second dirt-collecting bin.

In a further embodiment, the second dirt-collecting bin is positioned axially above the first dirt-collecting bin.

In a further embodiment, the airstream outlet is positioned in a lower portion of the housing. The airstream outlet is positioned concentrically with respect to the second cyclonic airflow chamber.

In a further embodiment, the filter element is a foraminous wall.

In a further embodiment, a separator plate is positioned between the first cyclonic airflow chamber and the first dirt-collecting bin. The relative cross-sectional area of the separator plate with respect to the housing is in the range of 0.75 to 0.95.

In a further embodiment, at least one vane is positioned between the first and second cyclonic airflow chambers for imparting a tangential velocity component to the airflow.

In a further embodiment according to the invention, a vacuum cleaner comprises a housing defining a cyclonic airflow chamber for separating contaminants from a dirt-containing airstream, and an airstream inlet and an airstream outlet in fluid communication with the cyclonic airflow chamber. A nozzle base includes a main suction opening fluidly connected with the cyclonic airflow chamber inlet. An airstream suction source is fluidly connected to the main suction opening and to the cyclonic airflow chamber inlet for drawing the dirt-containing airstream from the main suction opening and passing the dirt-containing airstream to the cyclonic airflow chamber. The main suction source selectively establishes and maintains the dirt-containing airstream from the main suction opening to the cyclonic airflow chamber inlet. A main filter assembly includes a filter element for filtering residual contaminants from the suction airstream. A dirt-collecting bin is beneath the cyclonic airflow chamber within the housing. The cyclonic airflow chamber is formed by a tangential helical ramp.

In a further embodiment, the main filter assembly is concentric with cyclonic airflow chamber.

In a further embodiment, there is an opening from the cyclonic airflow chamber into the dirt-collecting bin and an opening from the dirt-collecting bin into the main filter assembly whereby the airstream changes direction to enter the main filter assembly.

In a further embodiment, the airstream outlet is centrally located within the housing. The airstream outlet passes through the dirt-collecting bin.

### BRIEF DESCRIPTION OF THE DRAWINGS

In the drawings:

FIG. 1 is a front view of a suction cleaner housing with cyclonic dirt separation according to the invention.

FIG. 2 is a side view of the suction cleaner of FIG. 1.

FIG. 3 is a rear view of the suction cleaner of FIGS. 1-2.

FIG. 4 is an exploded perspective view of a dirt collection assembly of the suction cleaner of FIGS. 1-3.

FIG. 5 is an exploded perspective view of an upper housing and a motor housing of the suction cleaner of FIGS. 1-3.

FIG. 6 is a front view of a cylindrical separator of the suction cleaner of FIGS. 1-5.

FIG. 7 is a cross-sectional view through line 7-7 of FIG. 6.

FIG. 8 is a cross-sectional view taken through line 8-8 of FIG. 2.

FIG. 9 is a cross-sectional view taken through line 9-9 of FIG. 2.

FIG. 10 is a cut-away perspective view of the suction cleaner of FIGS. 1-9 showing air flow around the cylindrical separator in the dirt collection assembly.

FIG. 11 is a cut-away perspective view of the cylindrical separator of FIGS. 1-10 showing an internal axial air flow.

FIG. 12 is a cut-away perspective view of a further embodiment of a cyclonic separator for a suction cleaner according to the invention.

FIG. 13 is a front cross-sectional view of the cyclonic separator of FIG. 12.

FIG. 13A is a front cross-sectional view of a further embodiment of a cyclonic separator according to the invention.

FIG. 14 is a cross-sectional view taken through line 14-14 of FIG. 13.

FIG. 15 is a cut-away perspective view of a further embodiment of a dirt collection assembly with cyclonic dirt separation according to the invention.

FIG. 16 is an exploded perspective view of another embodiment of a dirt collection assembly with cyclonic dirt separation according to the invention.

FIG. 17 is an enlarged perspective view of a filter assembly for the dirt collection assembly of FIG. 16.

FIG. 18 is an enlarged perspective view of a cyclonic separator of the dirt collection assembly of FIG. 16.

FIG. 19 is a plan view of the dirt collection assembly of FIG. 16.

FIG. 20 is a cross-sectional view of the dirt collection assembly taken through line 20-20 of FIG. 19.

### DESCRIPTION OF THE PREFERRED EMBODIMENT

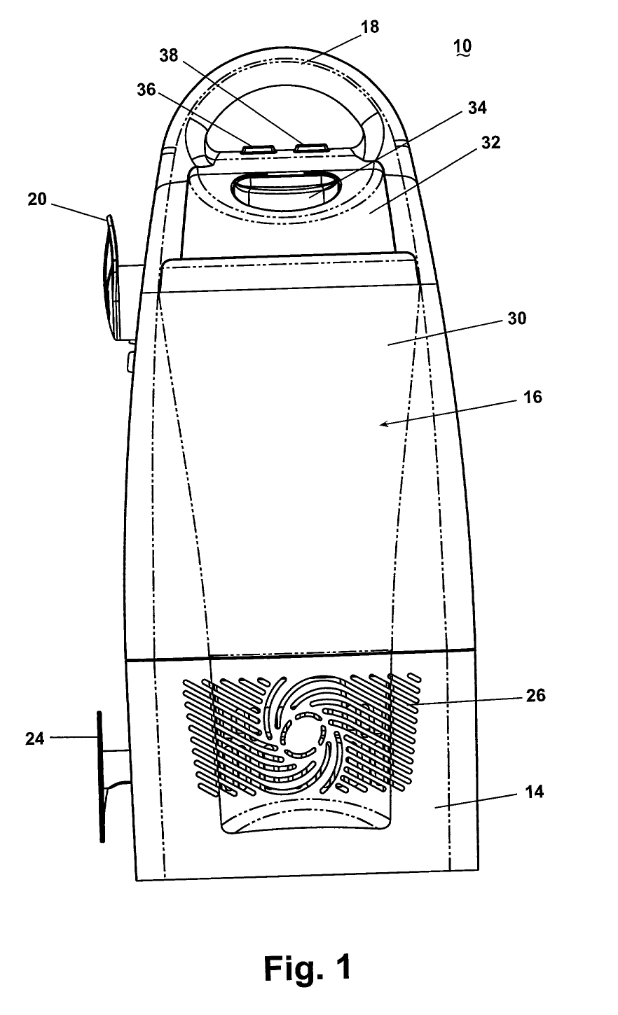

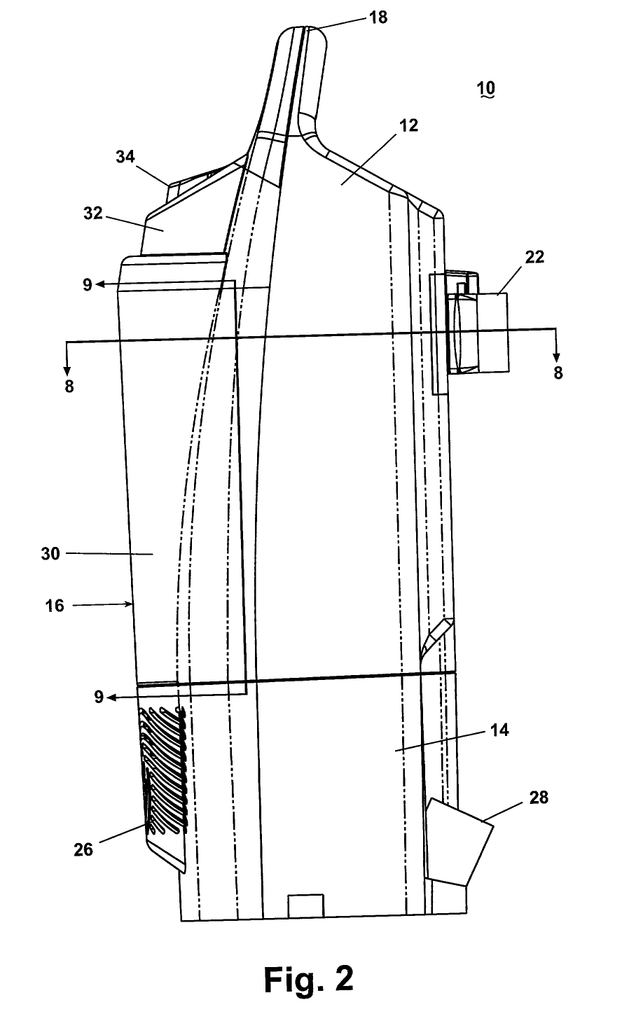

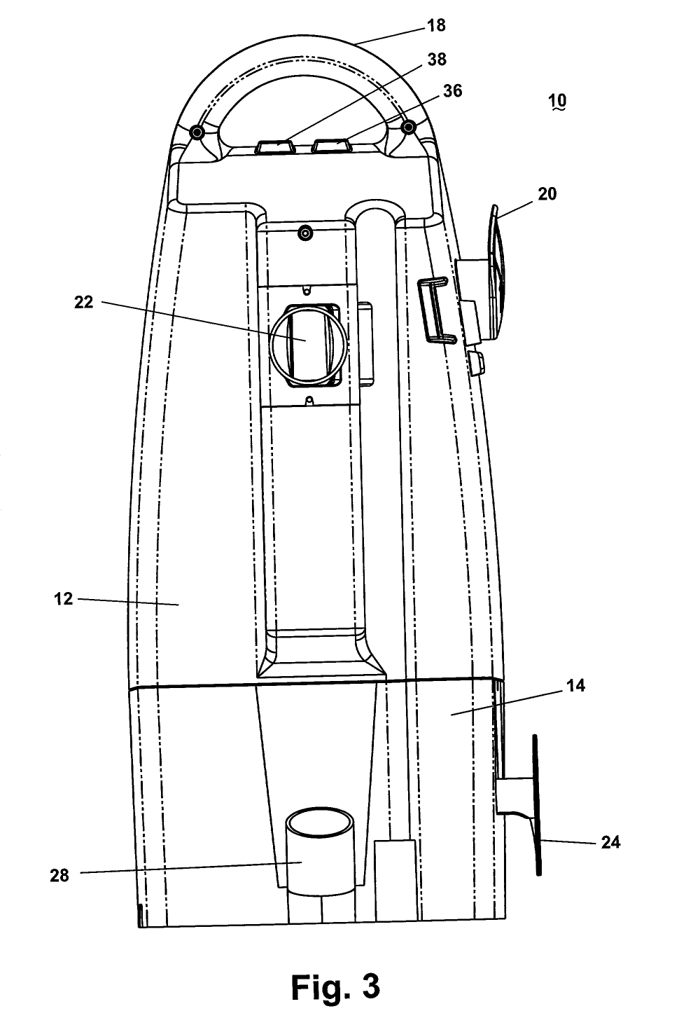

With reference to FIGS. 1-3, a suction cleaner with cyclonic dirt separation 10 comprises an upper housing 12, a motor housing 14, and a dirt collection assembly 16. The upper housing 12 includes a two-piece handle 18, an upper cord wrap 20, and an air inlet 22. The upper housing 12 further includes first and second switches 36, 38. The motor housing 14 includes a lower cord wrap 24, an exhaust air vent 26 and a floor suction conduit 28. The dirt collection assembly 16 comprises a dirt tank 30, a tank cap 32, and a tank latch 34. Each of the dirt collection assembly 16, upper housing 12, and motor housing 14 are configured to be assembled to present a smooth, continuous appearance, and to be generally fluid-tight.

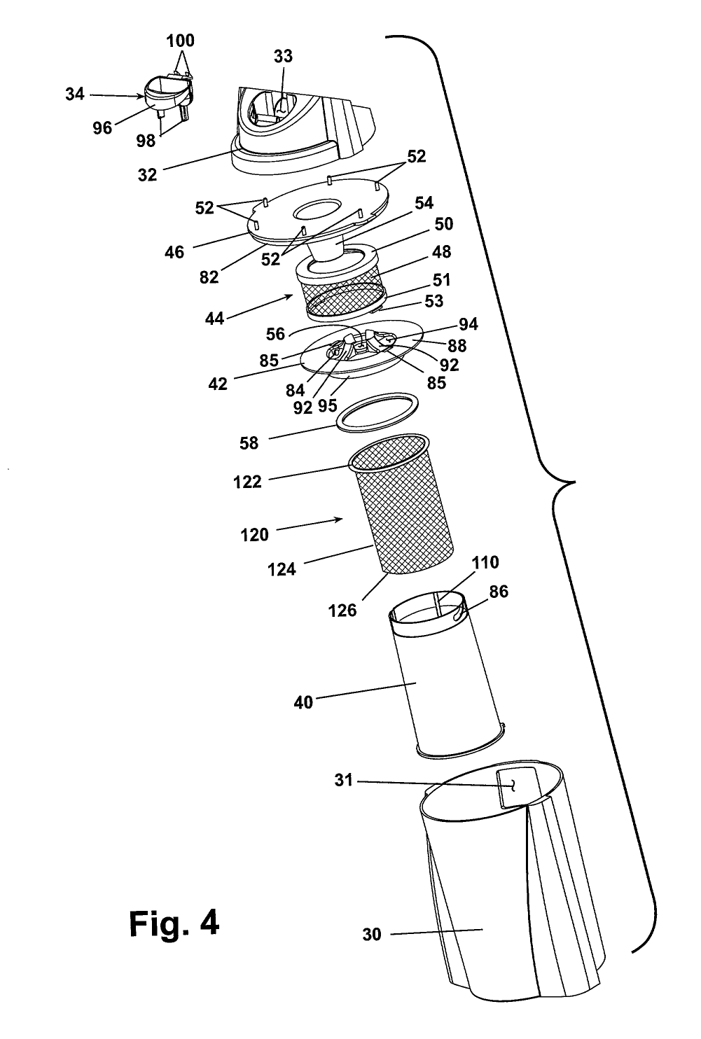

The dirt collection assembly 16, as shown in FIG. 4, includes the dirt tank 30, the tank cap 32 and the tank latch 34, and further includes a cylindrical separator 40, a secondary filter cup 120, a gasket 58, a separator plate 42, a cylindrical preliminary filter 44, and a top plate 46. Dirt tank 30 includes an air inlet aperture 31. Tank cap 32 includes tank latch recess 33 for receiving tank latch 34. Tank latch 34 is an integral molding including a body portion 96, two generally downwardly depending leaf springs 98, and two rearwardly extending catches 100. Cylindrical separator 40 is a hollow cylinder and includes in its interior radially inwardly projecting ribs 110, and on its exterior twist-and-lock grooves 86. Secondary filter cup 120 includes an upper rim 122, cylindrical side wall 124, and bottom wall 126. Gasket 58 is annular and resilient for forming a compressive seal. Separator plate 42 is substantially annular, having an outer perimeter flange 88, and further including an inner portion having upwardly extending separator plate radial ribs 92 joined at a central hub and defining a central cavity 56, and separator plate apertures 94 defined radially between radial ribs 92. Separator plate 42 further includes filter alignment slots 85 adjacent radial ribs 92. Separator plate 42 further includes a depending skirt 95, skirt 95 having inwardly projecting tabs 84 for receipt in twist-and-lock grooves 86. Preliminary filter 44 includes a filter element 48 in the form of a fine mesh screen, and upper and lower filter frames 50, 51. Lower filter frame 51 includes alignment tabs 53 for receipt in alignment slots 85 of separator plate 42. Top plate 46 includes upwardly projecting studs 52 and a downwardly projecting frusto-conical portion 54. Filter element 48 has been found to be effective with a fine mesh having openings as small as 40 microns.

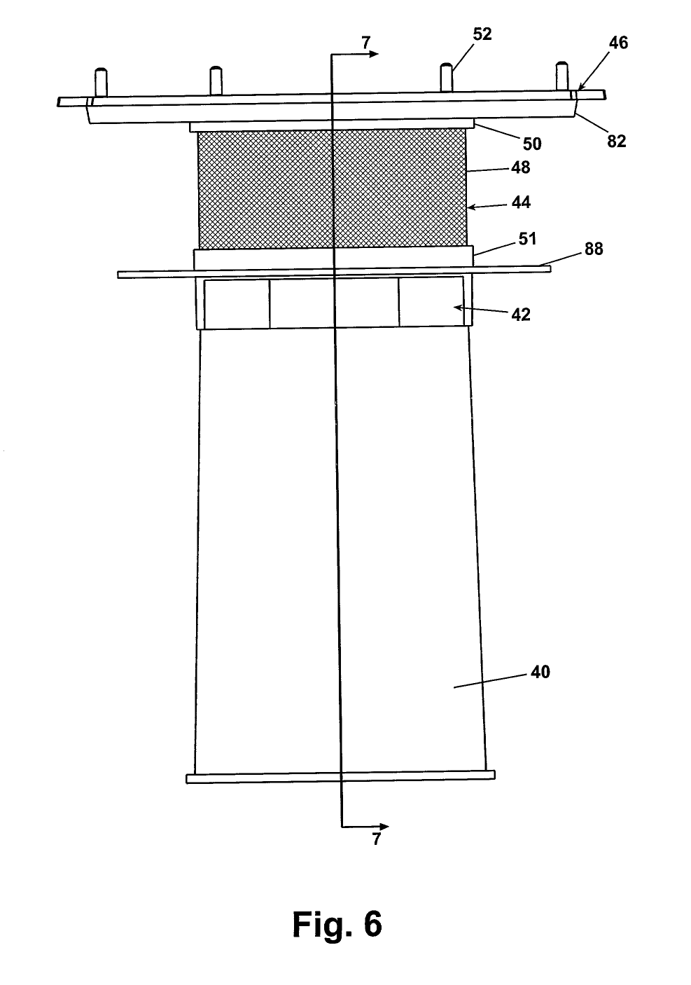

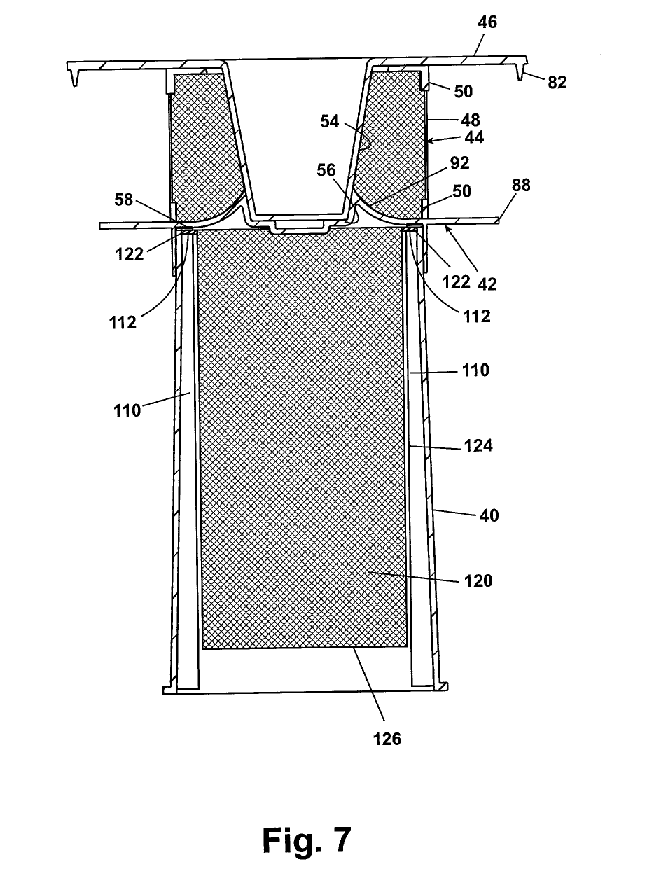

Referring now to FIGS. 6-7, ribs 110 of separator 40 each having an upper end 112 slightly recessed from the upper end of separator 40. Separator 40 receives cup 120 so that ribs 110 support rim 122, suspending cup 120 within separator 40, rim 122 being substantially flush with the upper end of separator 40. Separator plate 42, with gasket 58, is then received on separator 40 in a twist-and-lock arrangement using tabs 84 and grooves 86, creating a sealing arrangement between plate 42 and separator 40, and holding cup 120 in place against ribs 110. Prior to placement of plate 42 on separator 40, preliminary filter 44 is aligned on separator plate 42 using tabs and slots 53, 85, coaxial with cylindrical separator 40. Frusto-conical section 54 is configured to fill central cavity 56 formed in the separator plate 42 to sandwich preliminary filter 44 therebetween. Preliminary filter 44 is thereby sealingly received between the top plate 46 and the separator plate 42 when the frusto-conical section 54 of the top plate 46 is received in the central cavity 56 of the separator plate 42. The pins 52 projecting from the top plate 46 are received in recesses (not shown) on the underside of the tank cap 32 for holding and aligning the top plate 46 to the tank cap 32.

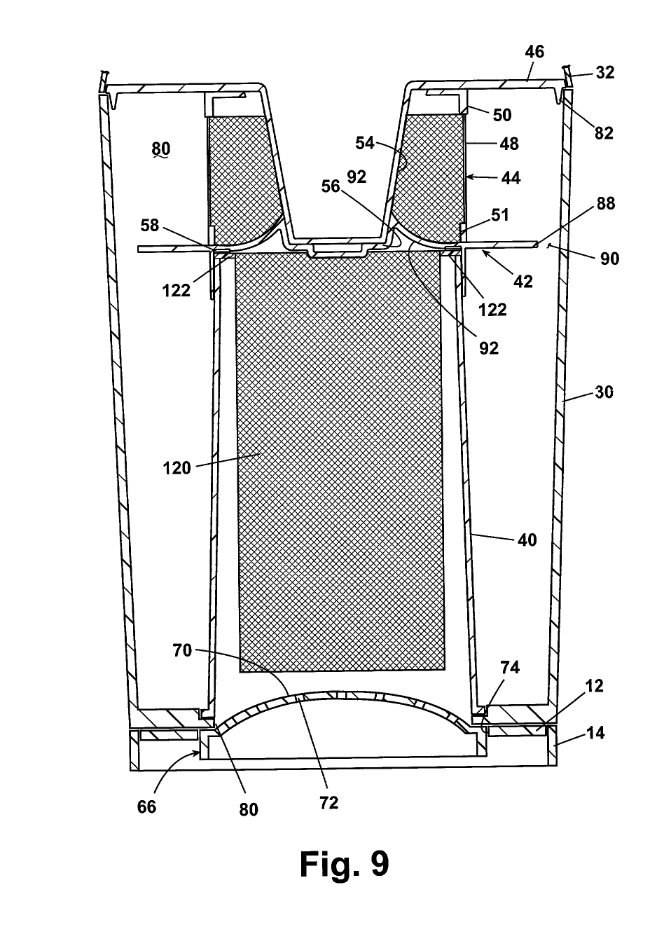

Referring again to FIG. 4, and to FIG. 9, the dirt collection assembly 16 comprises dirt tank 30 having a generally cylindrical interior, and having a central aperture 76 on the bottom thereof. The cylindrical separator 40 is coaxially received within the dirt tank 30, so that the open end of the hollow cylindrical separator 40 is aligned with and sealingly engages the perimeter of the central aperture 76 of the dirt tank 30. The cylindrical separator 40 is preferably affixed to tank 30 at central aperture 76, such as by welding. The assembly comprising the tank cap 32, top plate 46, preliminary filter 44, and separator plate 42 are received within the upper end of dirt tank 30 as separator plate 42 is received on the cylindrical separator 40 in the twist-and-lock arrangement of tabs and grooves 84, 86. The perimeter of the top plate 46 includes a canted lip 82 configured to fit inside the upper edge of the tank 30 in a sealing fit. The top plate 46 is fixed within the tank cap 32, so that when the top plate is fit within the top of the dirt tank 30, the exterior of the tank cap 32 aligns with the exterior of the dirt tank 30 to provide a uniform flush surface. The separator plate 42 includes a perimeter flange 88 having a diameter less than the interior diameter of the dirt tank 30, resulting in an annular gap 90 between the separator plate 42 and the side walls of the dirt tank 30.

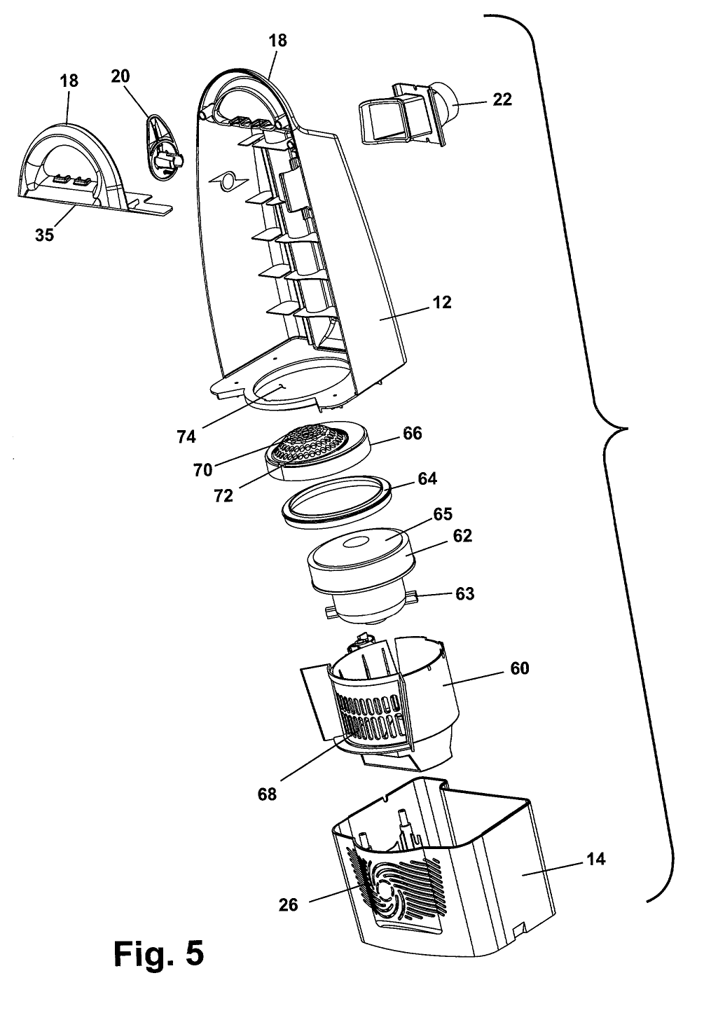

The motor housing 14 having exhaust air vent 26, shown in FIG. 5, further comprises a motor cage 60 having exhaust vents 68, a motor/impeller assembly 62, an impeller gasket 64 and a motor cover 66. Motor/impeller assembly 62 includes motor brushes 63, impeller intake 65, and motor electrical connections (not shown). Motor/impeller assembly 62 is closely received within motor cage 60, motor cage 60 further comprising integral ribs (not shown) that cooperate with the exterior of motor/impeller assembly 62 in a nesting relationship. Motor cover 66 includes a raised intake port 70 having apertures 72. Gasket 64 is configured to create a fluid seal between motor cover 66 and motor/impeller assembly 62 so that impeller intake 65 is in sealed fluid communication with intake port 70. Motor cage 60 and motor cover 66 are configured to enclose motor/impeller assembly 62 and gasket 64, providing sealed fluid communication between the motor cover 66 and exhaust vents 68, through motor/impeller assembly 62. Motor housing 14 is configured to mate with the bottom of the upper housing 12 so that the motor cover 66 sealingly fills central aperture 74, and the bottom of the upper housing 12 sealingly covers the motor housing 14. Assembly of the motor cage 60 within the motor housing 14, and further assembly of the motor housing 14 to the upper housing 12, therefore creates a sealed fluid path between the interior of the upper housing 12 at apertures 72 of the motor cover 66, to exhaust outlet 26 of motor housing 14, through motor/impeller assembly 62.

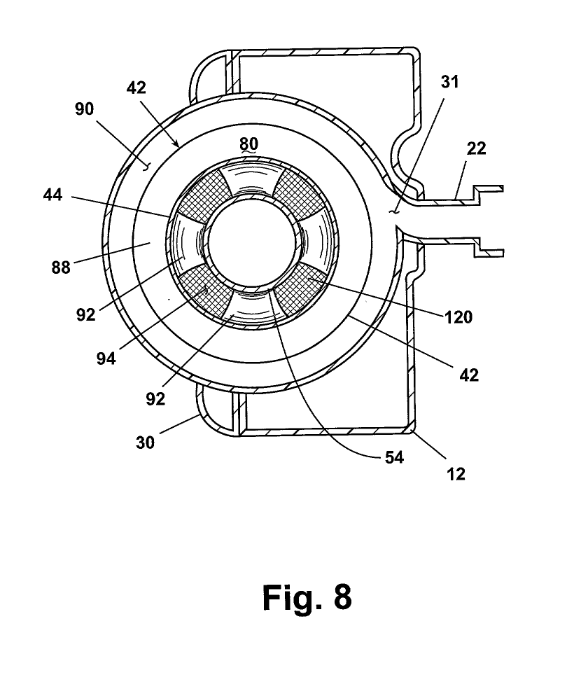

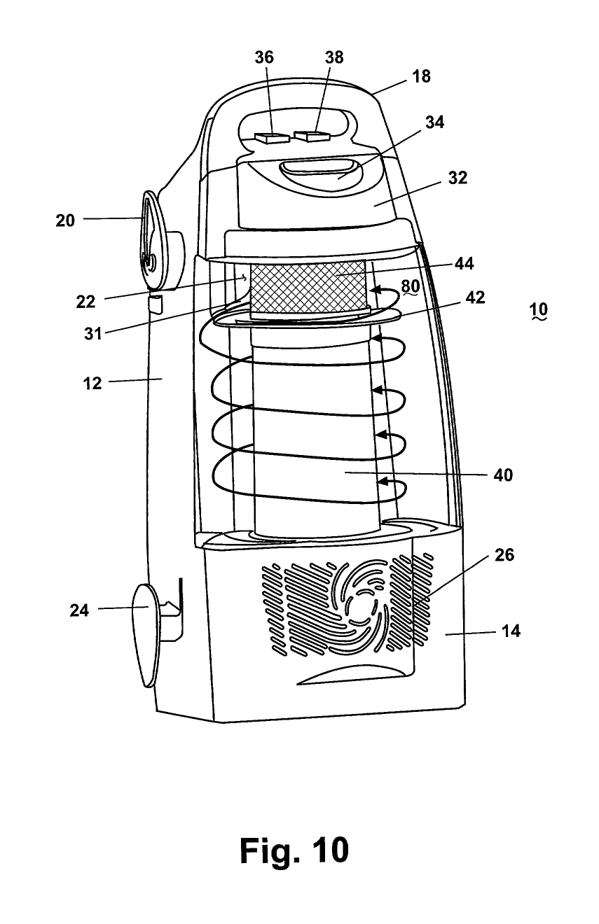

Referring now to FIGS. 8-11, the dirt collection assembly 16 can be assembled and inserted into the upper housing 12 so that the cylindrical separator 40 within the tank 30 is aligned with and fluidly connected with the motor cover 66, and the inlet aperture 31 of the dirt tank 30 is further fluidly connected with the air inlet 22, as particularly shown in FIGS. 8 and 10. Dirt collection assembly 16 is held in upper housing 12 by tank latch 34 as will be further described below. The air inlet 22 is therefore fluidly connected to the exhaust air vent 26 of the motor housing 14 through the aperture 31 of the dirt tank 30, the preliminary filter element 44, the separator plate 42, the hollow cylindrical separator 40, the apertures 72 of the raised portion 70 of the motor cover 66, the motor impeller assembly 62, and the exhaust vent 68 of the motor cage 60.

The user controls the suction cleaner by activating one of the switches 36, 38 to supply power to the motor impeller assembly 62. When the motor impeller assembly 62 is activated, a suction force is generated at the motor cover 66, causing a flow of air from the motor cover 66 through the motor impeller assembly 62, motor cage 60 and into the motor housing 14, and then to atmosphere through the exhaust air vent 26. A post-motor filter (not shown) is configured to fully occupy, and is inserted in, the space between exhaust vents 68 and exhaust air vent 26. When the motor cover 66 is sealingly and fluidly connected to the cylindrical separator 30, as in when the dirt collection assembly 16 is fully installed in the upper housing 12, the suction force is fluidly connected through the cylindrical separator 30, separator plate 42, preliminary filter 44 and aperture 31 to the air inlet 22. A suction hose or nozzle of known construction is generally attached to the air inlet 22 for use in cleaning a surface.

As air is drawn into the air inlet 22, the air inlet 22 imparts a tangential component to the inlet air, as shown in FIG. 10, as it enters the dirt tank 30 through the aperture 31. The air enters the dirt tank 30 in a toroidal section of the dirt tank formed between top plate 46 and separator plate 42, and between the preliminary filter 44 and the interior tank wall. As the air flows in a tangential direction about the dirt tank 30, heavier particles of dirt and debris are propelled outwardly by centrifugal force and fall under the force of gravity through the gap 90 formed between the perimeter flange 88 of the separator plate 42 and the dirt tank 30 into the lower portion of the dirt tank 30. It has been found that separator plate 42 acts as a separator between two air velocity zones, one existing in the toroidal chamber 80 having a relatively high rotational air velocity, and a second zone separated from the toroidal chamber 80, below separator plate 42, having a much lower rotational air velocity. The high rotational air velocity in the toroidal chamber 80 forces dirt particles contained in the airstream to the outside of the chamber where they will be drawn through the gap 90 to the outside of flange 88. As the airstream flows into the zone beneath the separator plate 42 and the air velocity decreases, the dirt particles will fall out of the airstream and collect and the dirt tank 30. It has been found that narrowing the gap 90, in the sense of having a high ratio of the surface area of the plate 42 to the overall cross-sectional area of the housing, is beneficial to maintaining the two air velocity zones. This must be balanced with maintaining a gap 90 large enough to enable passage of larger dirt particles such as hair, carpet fuzz, etc. A relative plate surface area in the range of 0.75 to 0.95 with respect to the housing cross-sectional area is effective in defining the two air velocity zones while enabling the passage of large dirt particles, with the preferred ratio of surface areas being 0.8 to 0.92, or optimally 0.9.

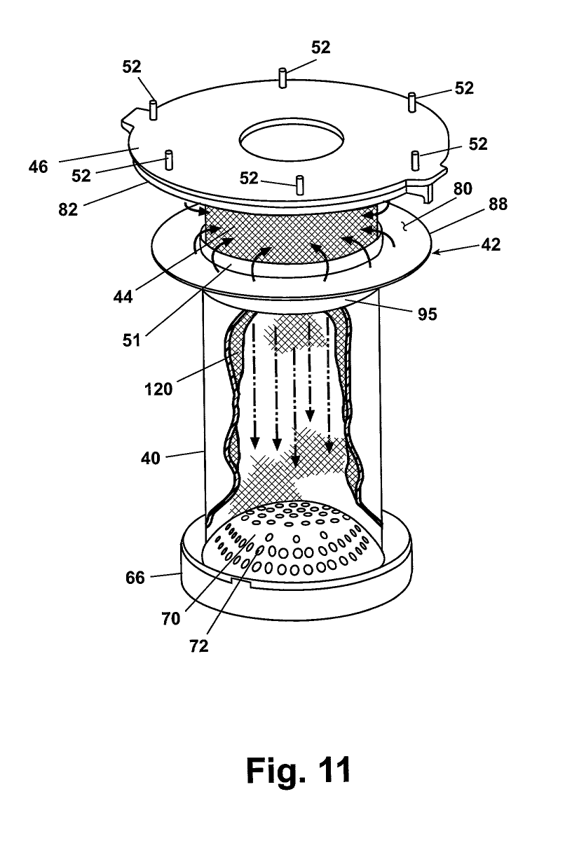

The air flow circulates tangentially about the interior of the tank 30 until it is drawn inwardly toward the preliminary filter element 44, as shown in FIG. 11. As the air flow passes through the preliminary filter element 44, the filter element 44 prevents larger dirt particles and debris, that did not fall to the lower portion of the dirt tank 30, from passing into the interior of filter element 44 and then into the interior of separator 40 and filter cup 120. The air is then drawn downwardly between separator plate radials 92 through separator plate apertures 94 (see FIG. 8), through filter cup 120 which traps additional finer particles, and passes axially through the hollow interior of the cylindrical separator 40, then through apertures 72 and the motor housing 14 to atmosphere through the post motor filter (not shown) and the exhaust air vent 26.

Dirt and debris, when collected in the dirt tank 30, can be discarded by removing the dirt collection assembly 16 from the upper housing 12. Dirt collection assembly 16 is retained in upper housing 12, as stated above, by tank latch 34 on tank cap 32. Leaf springs 98 bias latch 34 upwardly by pressing against the bottom of recess 33, forcing the catches 100 underneath a lip 35 of the handle 18, thereby retaining the tank cap 32 against the handle 18. Latch 34 is released by depressing the latch body 96 against the biasing force of the leaf springs 98, thereby releasing the catches 100 from the lip 35. The dirt collection assembly 16 can then be tilted away from the housing portion 12. With the dirt collection assembly 16 removed from the upper housing 12, the assembly comprising tank cap 32, top plate 46, preliminary filter 44 and separator plate 42, can be removed from dirt tank 30 and cylindrical separator 40 as a unit by counter-clockwise rotation of the twist-and-lock arrangement of tabs and grooves 84, 86. The upper portion of the dirt tank 30 and the filter cup 120 are thus open so that they can be emptied by a user. Filter cup 120 can further be removed from separator 40 for cleaning, and top plate 46 can be further separated from the separator plate 42 for cleaning or replacement of the preliminary filter assembly 44. Upon reassembly as described above, dirt collection assembly 16 is replaced in upper housing 12 by inserting the lower portion of the assembly 16 into the housing portion 12 and tilting it inwardly until catches 100 resiliently slide past lip 35 to bias upwardly and engage lip 35 and hold assembly 16 in place in upper housing 12.

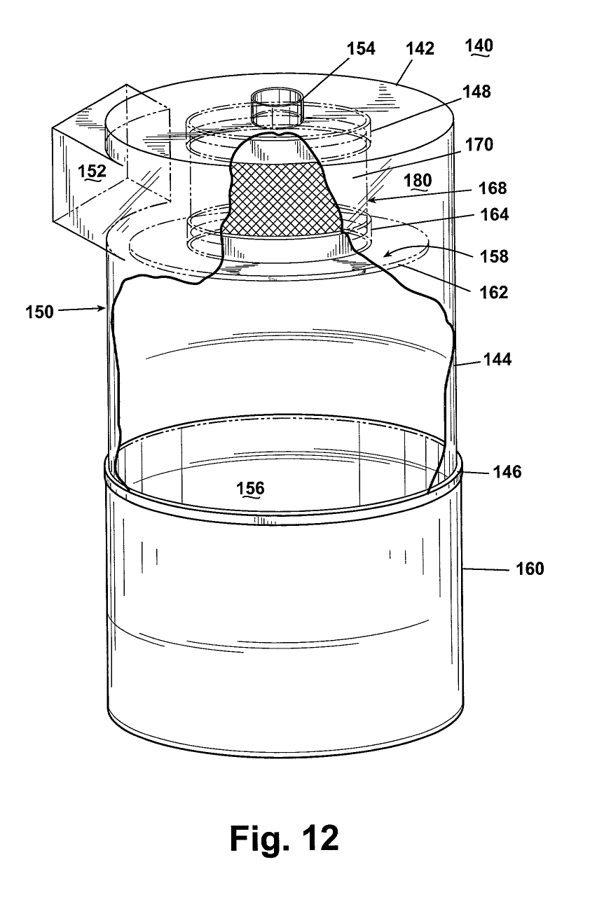

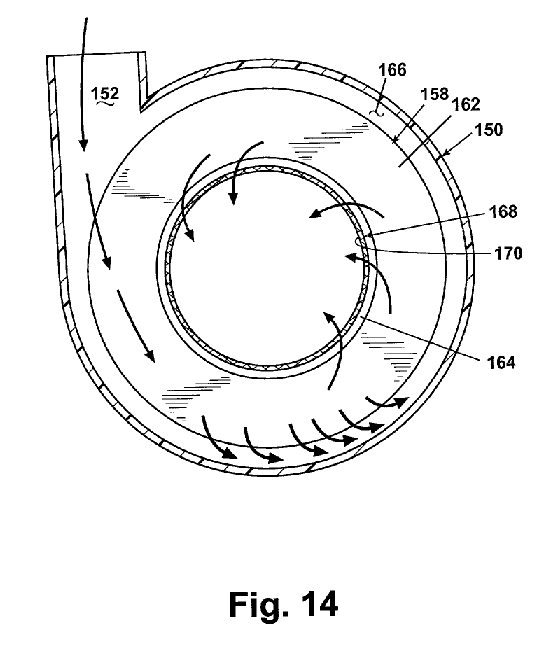

Referring to FIG. 12, a further embodiment of a cyclonic dirt separator 140 according to the invention comprises a cylindrical cyclone chamber 150 having an upper wall 142 and a sidewall 144, the sidewall 144 terminating in a lower offset lip 146. An annular collar 148 depends from upper wall 142, the collar 148 being centered in the cylindrical chamber 150. An exhaust outlet 154 in the upper wall 142 and within the annular collar 148 is fluidly connected with a suction source (see FIG. 14). Sidewall 144 further includes a tangential air inlet 152 aligned proximate the upper wall 142 for generating a tangential airflow in the chamber 150 parallel to the upper wall 142.

The cyclonic dirt separator 140 further comprises a primary filter element 168. In a preferred embodiment, the primary filter element 168 comprises a cylindrical fine mesh screen 170 retained by the collar 148 that depends from upper wall 142 of the chamber 150. Cyclonic dirt separator 140 further comprises a separator plate 158 in the form of a solid disc having an upstanding annular collar 164. In the preferred embodiment, the upstanding annular collar 164 is aligned with the depending collar 148 of the upper wall 142 so that the cylindrical screen 170 is retained at the ends thereof by each of the collars 148, 164. In this manner, separator plate 158 is suspended from upper wall 142, forming a toroidal chamber 180 between the cylindrical screen 170 and the sidewall 144, and between the upper wall 142 and the separator plate 158, respectively. In the preferred embodiment, air inlet 152 is vertically aligned between upper wall 142 and separator plate 158 such that the tangential airflow generated from tangential air inlet 152 is directed into the toroidal chamber 180.

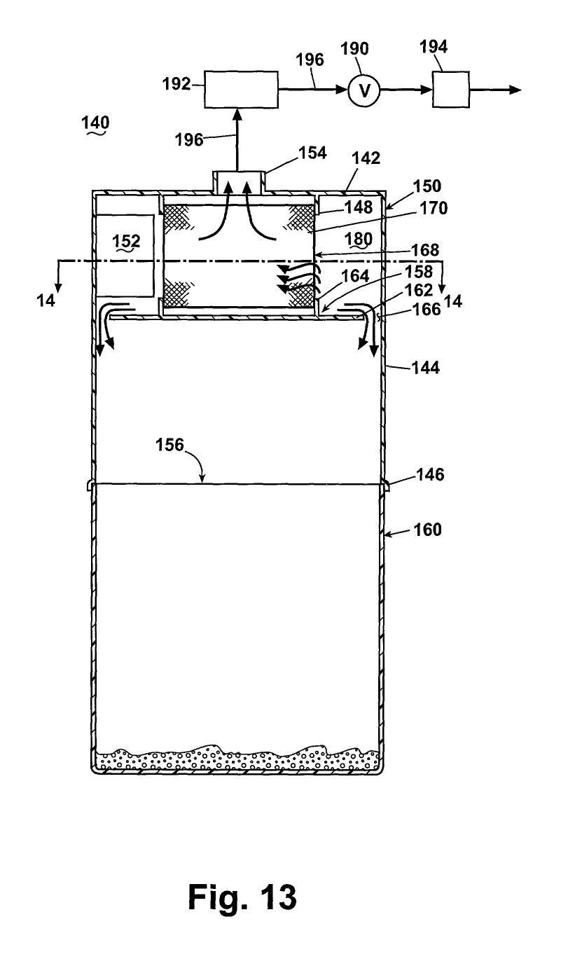

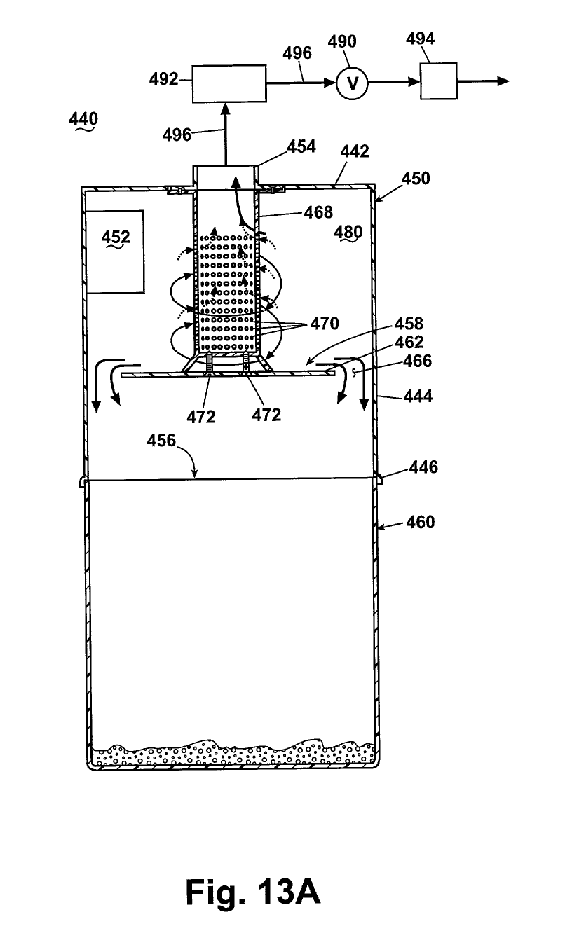

With further reference to FIGS. 13-14, the tangential airflow, containing particulate matter, passes through tangential air inlet 152 and into toroidal chamber 180 to travel around the cylindrical screen 170. As the air travels about the toroidal chamber 180, heavier dirt particles are forced toward sidewall 144. These particles will fall under the force of gravity through a gap 166 defined between an edge 162 of separator plate 158 and the sidewall 144. Referring particularly to FIG. 13, dirt particles falling through the gap 166 drop through the open end 156 of chamber 150 and are collected in the dirt cup 160. The upper end of dirt cup 160 is received in a nesting relationship in lower offset lip 146 of the sidewall 144 to seal the cyclone chamber 150 to the dirt cup 160.

As the inlet air traverses through toroidal chamber 180, casting dirt particles toward sidewall 144, the inlet air will be drawn through cylindrical screen 170, through exhaust outlet 154, exhaust/suction conduit 196, through a secondary (pre-motor) filter 192 to the suction source 190. The secondary filter 192 removes additional particulate matter from the exhaust airstreams prior to the airstreams being drawn through the suction source 190. A post-motor filter 194 can also be provided downstream of the suction source 190 to remove additional fine particulate matter from the exhaust airstream before it is released to the atmosphere.

Dirt cup 160 is removably connected to chamber 150. Accumulated dirt can be discarded by axially displacing dirt cup 160 from cyclone chamber 150 so that it disengages from offset lip 146. Dirt cup 160 can then be removed from chamber 150 to discard accumulated dirt.

A further embodiment of a cyclonic separator 440 is shown in FIG. 13A. the cyclonic separator 440 comprises a cylindrical cyclone chamber 450 having an upper wall 442 and a sidewall 444, the sidewall 444 terminating in a lower offset lip 446. A substantially cylindrical filter assembly 468 depends from upper wall 442, being centered in the cylindrical chamber 450. An exhaust outlet 454 in the upper wall 442 and within the filter assembly 468 is fluidly connected with a suction source 490. Sidewall 444 firther includes a tangential air inlet 452 aligned proximate the upper wall 442 for generating a tangential airflow in the chamber 450 parallel to the upper wall 442.

In a preferred embodiment, the filter assembly 468 comprises a plurality of apertures 470 passing through the wall of the assembly 468 and fluidly connecting air inlet 452 with exhaust outlet 454. Cyclonic dirt separator 440 further comprises a separator plate 458 in the form of a solid disc. Separator plate 458 is secured by fasteners 472 to a lower end of cylindrical filter assembly 468, parallel to upper wall 442, forming a toroidal chamber 480 between the cylindrical filter assembly 468 and the sidewall 444, and between the upper wall 442 and the separator plate 458, respectively. In the preferred embodiment, air inlet 452 is vertically aligned between upper wall 442 and separator plate 458 such that the tangential airflow generated from tangential air inlet 452 is directed into the toroidal chamber 480.

As in the previous embodiment, the tangential airflow, containing particulate matter, passes through tangential air inlet 452 and into toroidal chamber 480 to travel around the cylindrical filter assembly 468. As the air travels about the toroidal chamber 480, heavier dirt particles are forced toward sidewall 444. These particles will fall under the force of gravity through a gap 466 defined between an edge 462 of separator plate 458 and the sidewall 444. Dirt particles falling through the gap 466 drop through the open end 456 of chamber 450 and are collected in the dirt cup 460. The upper end of dirt cup 460 is received in a nesting relationship in lower offset lip 446 of the sidewall 444 to seal the cyclone chamber 450 to the dirt cup 460.

As the inlet air traverses through toroidal chamber 480, casting dirt particles toward sidewall 444, the inlet air will be drawn through the apertures 470 in cylindrical filter assembly 468, through exhaust outlet 454, exhaust/suction conduit 496, through a secondary (pre-motor) filter 492 to the suction source 490. The secondary filter 492 removes additional particulate matter from the exhaust airstreams prior to the airstreams being drawn through the suction source 490. A post-motor filter 494 can also be provided downstream of the suction source 490 to remove additional fine particulate matter from the exhaust airstream before it is released to the atmosphere.

Dirt cup 460 is removably connected to chamber 450. Accumulated dirt can be discarded by axially displacing dirt cup 460 from cyclone chamber 450 so that it disengages from offset lip 446. Dirt cup 460 can then be removed from chamber 450 to discard accumulated dirt.

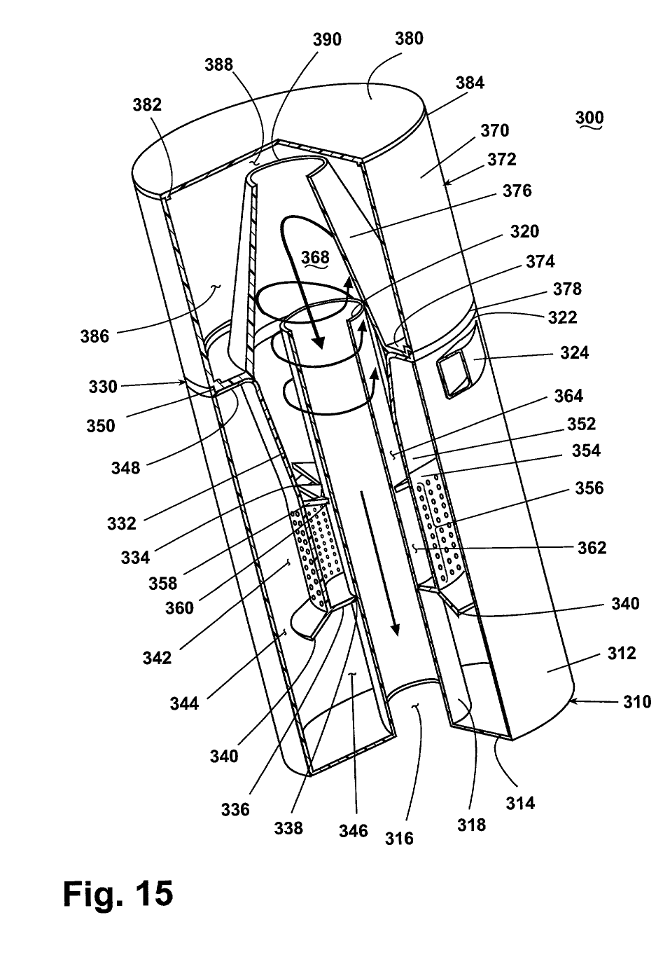

A further embodiment of a cyclonic separator 300 is depicted in FIG. 15. The cyclonic separator 300 comprises a dirt bin 310 having a cylindrical configuration with an exterior wall 312, a bottom wall 314 having a central opening 316 integral with a hollow cylindrical shaft 318 extending from bottom wall 314. Shaft 318 includes an upper end 320 and extends coaxially within bin 310 so that upper end 320 extends above an upper end 322 of exterior wall 312 of dirt bin 310. Dirt bin 310 firther comprises a tangential inlet opening 324 passing through the exterior wall 312 of the dirt bin 310, located proximate the upper end 322 of the exterior wall 312 of the dirt bin 310.

The cyclonic separator 300 further comprises a cyclonic insert 330 having a substantially hollow cylindrical body 332, cylindrical body 332 shown as having a neck portion 334 in a central area thereof, so that the diameter of the cylindrical body 332 is slightly narrower at neck portion 334. Cylindrical body 332 is further contemplated as being uniform in diameter, i.e. eliminating neck portion 334. Cyclonic insert 330 further comprises an annular bottom portion 336.

Annular bottom portion 336 includes a central opening 338 configured to closely conform to the exterior of the central shaft 318 of the dirt bin 310. Bottom portion 336 is connected to the exterior wall of the cylindrical portion 332 of the cyclonic insert 330, and further includes a separator flange 340. Separator flange 340 extends downwardly at an obtuse angle beyond the exterior wall of the cylindrical body 332.

The cylindrical body 332 of the cyclonic insert 330 has a diameter less than the diameter of the cylindrical dirt bin 310, so that when the cyclonic insert 330 is inserted into the dirt bin 310, a toroidal portion 342 is formed therebetween. The separator flange 340 does not extend to cylindrical wall 312, leaving a gap 344 between the separator flange 340 and the interior of the cylindrical wall 312 of the dirt bin 310.

The interior of the dirt bin 310 is thus divided into two toroidal portions 342, 346, the first toroidal portion 342 being between the cyclonic insert 330 and the wall 312 of the dirt bin 310, and the second toroidal portion 346 formed between the central shaft 318 and the cylindrical wall 312 of the dirt bin 310, beneath the separator flange 340.

The cyclonic insert 330 further comprises an upper annular flange portion 348 integrally formed with the cylindrical body 332 of the cyclonic insert 330, the flange portion 348 having an outer diameter equivalent to the outer diameter of the dirt bin 310 and configured to be received in an engaging and sealing manner on the upper edge 322 of the exterior wall 312 of the dirt bin 310.

The cylindrical body 332 of the cyclonic insert 330 further comprises two wall portions, an impervious upper wall portion 352 and a lower wall portion 354 having a plurality of perforations 356 passing therethrough. Perforations 356 are contemplated as being of uniform size and spacing, or of being arranged in a non-uniform pattern of varying apertures, as required to develop the most advantageous airflow pattern.

The cyclonic insert 330 further includes a plurality of canted vanes 358 arranged in a ring about the interior of the cyclonic insert 330 at the necked portion 334 of the cylindrical body 332. The vanes 358 include a central opening 360 configured to closely receive the central shaft 318 of the dirt bin 310.

The necked portion 334, and the vanes 358, substantially divide the volume between the cyclonic insert 330 and the central shaft 318 of the dirt bin 310 into two toroidal portions 362, 364. The first toroidal portion 362 is bounded on its interior by the central shaft 318 of the dirt bin 310, and on its exterior by the perforated section 354 of the cylindrical portion of the dirt bin 310. The second toroidal portion 364 is bounded on its interior by the central shaft 318 of the dirt bin 310 and on its exterior by the solid portion 352 of the cylindrical portion of the cyclonic insert 330. the second toroidal portion 364 is bounded at its lower end by the vanes 358 and at its upper end by a frusto-conical chamber 368 defined by a frusto-conical wall 376.

The cyclonic separator 300 further comprises a secondary cyclone chamber 370, the chamber 370 comprising an outer cylindrical wall 372, a lower annular wall 374 and frusto-conical wall 376. The bottom wall 374 of the chamber 370 has an annular perimeter 378 for abutting the perimeter edge 350 of the cyclone insert 330 to present a flush appearance and to resist removal of the chamber 370 from the insert 330.

The chamber 370 further comprises a chamber cap 380, being a disk having a depending rim 382 for receipt in an upper portion 384 of the cylindrical chamber 370 in a sealing manner. The exterior wall 372, lower wall 374 and frusto-conical wall 376 of the chamber 370 are integrally formed, forming a substantially toroidal receptacle 386. The frusto-conical wall 376 is shorter than the exterior walls 372 of the chamber 370 resulting in a gap 388 between a top edge 390 of the hollow frusto-conical wall 376 and the lid 380 of the chamber 370.

Prior to assembly, therefore, the cyclonic separator 300 comprises a cylindrical dirt bin 310 having a concentric cylindrical shaft 314 passing from an aperture 316 and a flat bottom 314 to above the upper edge 322 of the dirt bin 310, forming a single toroidal chamber therebetween. Inserting the cyclonic insert 330 in a sealing engagement with the upper edge 322 of the dirt bin 310 divides the interior of the dirt bin 310 into two toroidal portion 342, 346 to the outside of the insert 330. The toroidal portions 342, 346 are separated by the separator flange 340 of the cyclonic insert 330, except for a gap 344 between separator flange 340 and wall 312.

The interior of the insert 330 is divided into toroidal sections 362, 364 inside the cylindrical body 332 of the insert 330. The toroidal sections 362, 364 are defined by the vanes 358. The central shaft 318 still projects above the top 322 of the bin 310 and the upper flange 348 of the cyclonic insert 330.

Attaching the secondary cyclone chamber 370 and its lid 380 places the upper end 320 of the central shaft 318 within the hollow frusto-conical wall 376 of the secondary cyclone chamber 370. The cyclonic separator 300 is now sealed from the atmosphere except for the tangential inlet 324 of the dirt bin 310 and the central outlet 316 at the base 314 of the dirt bin 310. The tangential inlet 324 and outlet 316 are fluidly connected through the dirt bin 310, perforations 356 of the cyclonic insert 330, through the toroidal sections 362, 364 within the cyclonic insert 330 and through the upper end 320 of the central shaft 318.

The cyclonic separator, when used in a suction cleaner, will have a vacuum source fluidly connected to the outlet opening 316, thereby forming a vacuum within the cyclonic separator 300 and at the tangential inlet 324 to the dirt bin 310. Inlet 324 will be fluidly connected to a surface cleaning apparatus. Dirt-laden air will be drawn through the inlet 324 into the first toroidal section 342, the air flow having a tangential component due to the orientation of inlet 324. As the dirt-laden air is circulated about the perimeter of the dirt bin 310, the dirt will be driven toward the outer wall 312 of dirt bin 310 and tend to fall towards the bottom wall 314 to the outside of the separator flange 340.

As the air circulates about dirt bin 310, the air will be drawn inwardly toward the perforations 356 in the lower portion 354 of the cylindrical portion 332 of the cyclonic insert 330. Heavier particles of dirt will fall to the bottom of the dirt bin. The separator flange 340 acts to discourage dirt particles from being recirculated in the air flow adjacent the perforations 356.

The air passing through the perforations 356 continues to carry finer particulates that were not heavy enough to be deposited in the bottom of the dirt bin 310. The perforations 356 substantially pass perpendicularly through the surface 354 of the cyclonic insert 330 to further encourage deflection of dirt particles from the perforations and thereby removing them from the airflow.

As the air flow passes through the perforations 356, it begins traveling essentially along the outside of the central shaft 318. It is been found that this air flow still maintains some rotational velocity. In the embodiment shown in FIG. 15, the airflow will strike vanes 358. Vanes 358 will increase the rotational velocity component to the air flow. The air flow in the upper toroidal portion 364 will therefore have a tangential component to encourage additional cyclonic action in the toroidal section 364.

As the air flow travels to the frusto-conical chamber 368, the rotational velocity of the air flow will increase, driving dirt particles toward the frusto-conical wall 376 of the secondary cyclone chamber 370. In addition, the axial velocity components will push the dirt particles to the top opening 390. The tangential component will then direct the dirt particles to the outer secondary cyclonic chamber 370, through the gap 388. With very little airflow in the outer chamber of the secondary cyclonic chamber 370, the velocity of the dirt particles drops dramatically and the dirt particles fall to the bottom 386 of the secondary cyclonic chamber 370.

The remaining airflow, and those particles not having sufficient centripetal energy to be driven to the outside of the frusto-conical wall 376, will be drawn through the top end 320 of the central shaft 316, to be drawn to the vacuum source fluidly connected to the outlet opening 316. A fine particulate filter (not shown) is inserted in the exhaust airstream to remove those fine particulates not extracted by the cyclonic separator.

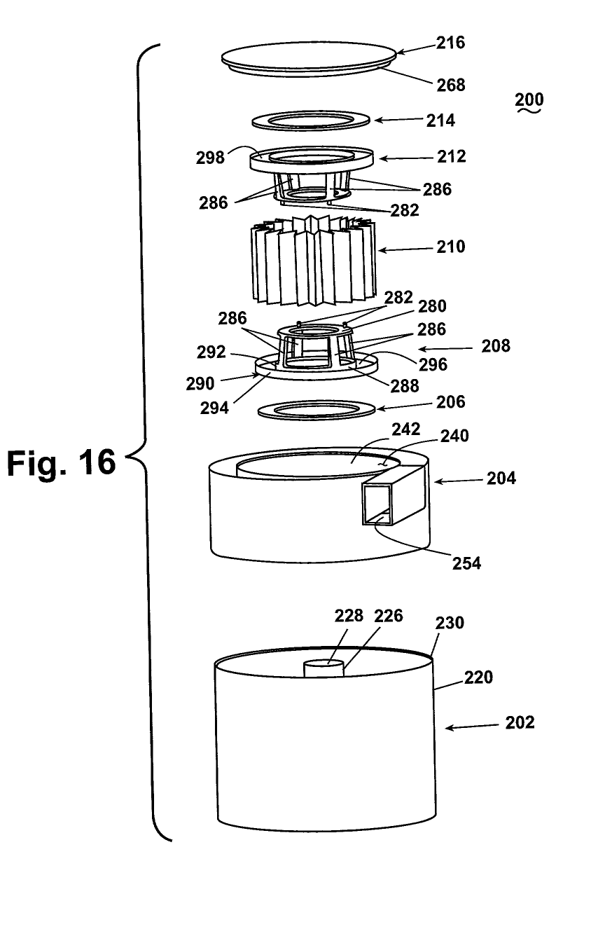

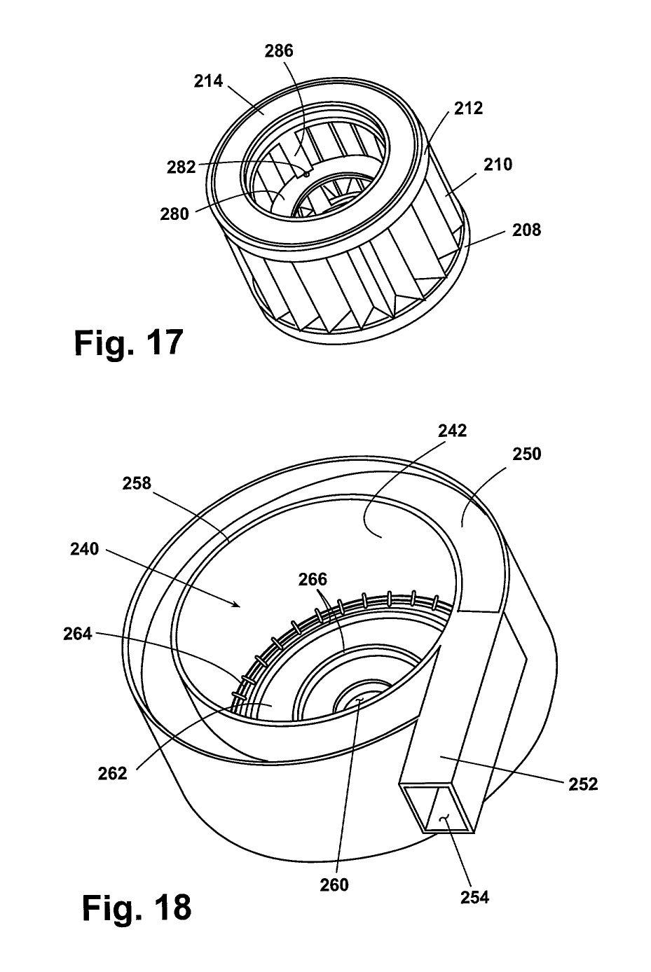

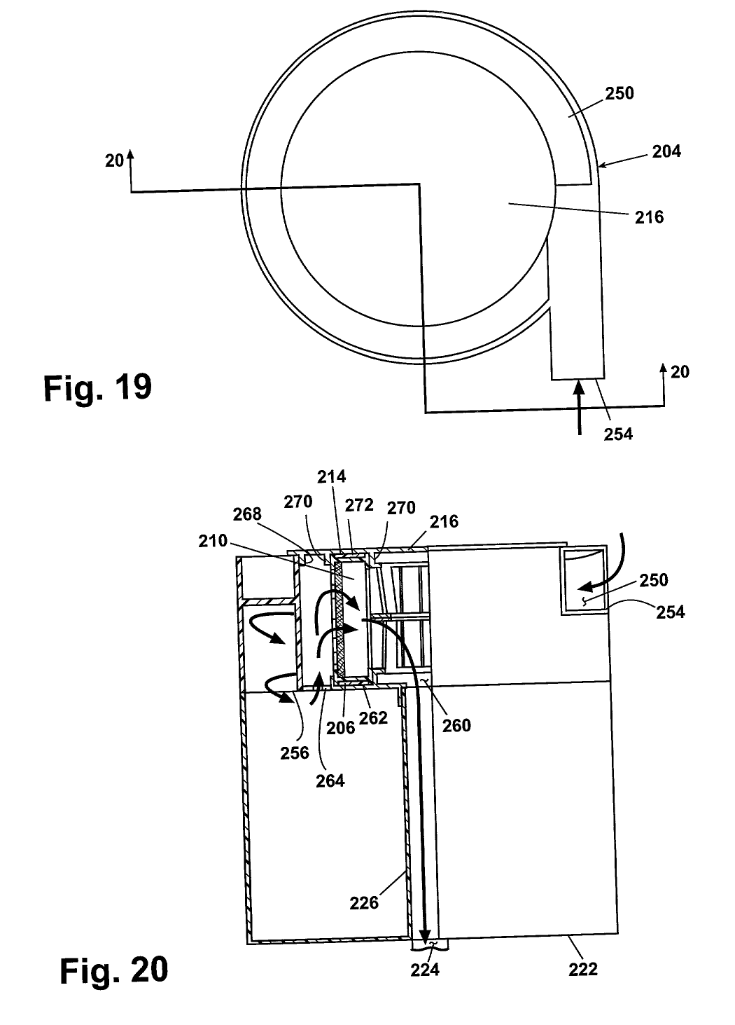

An additional embodiment of a cyclonic separator 200 for a suction cleaner is shown in FIGS. 16-20. Cyclonic separator 200 comprises a dirt bin 202, a cyclonic housing 204, first and second filter frames 208, 212, first and second filter seals 206, 214, filter medium 210, and filter chamber lid 216.

The dirt bin 202 is cylindrical in configuration, having an outer wall 220, a bottom wall 222 having a central opening 224, and a central cylindrical shaft 226 encompassing the aperture 224, the cylindrical shaft 226 being concentric with the outer wall 220 of the dirt bin 202. The central shaft 226 has an upper end 228 substantially even with an upper end 230 of the dirt bin outer wall 220. The dirt bin thereby comprises a toroidal receptacle encompassed by the outer wall 220 and the central shaft 226, and by the dirt bin lower surface 222 and the upper edges 228, 230 of the central shaft 226 and outer wall 220.

The cyclone housing 204 is cylindrical, having an exterior diameter equal to the diameter of the dirt bin 202. The cyclone housing 204 comprises a central cylindrical filter chamber 240 having an outer wall 242, the diameter of the cylindrical filter chamber 240 being smaller than the exterior diameter of the cyclone housing 204, but concentric therewith. The annular region defined between the outer wall 242 of the filter chamber 240 and the outer wall of the cyclone housing 204 comprises a spiral channel 250. Channel 250 begins at an upper portion 252 of the cyclone housing 204 with an inlet opening 254. The channel 250 then follows the perimeter of the cyclone housing in a downward spiral fashion to a channel outlet 256 on a lower portion of the cyclone housing 204.

The upper portion of the filter chamber 240 comprises a filter chamber opening 258. A lower portion of the filter chamber 240 comprises a central opening 260, an annular filter seat 262 surrounding the central opening 260 on the lower portion of the filter chamber 240, and an annular perforated inlet section 264. The annular filter seat 262 is bounded on its interior and exterior edges by a raised rim 266, each raised rim being annular and perpendicular to the base of the filter chamber 240.

The filter chamber lid 216 is a flat disc having a diameter slightly greater than the diameter of the cylindrical filter chamber 240, and having an annular depending rim 268 inset from the edge of lid 216 and adapted to be closely received within the opening 258 of filter chamber 240. Filter chamber lid 216 further comprises two additional depending annular rims 270 each having a diameter corresponding to one of the rims 266 surrounding the annular filter seat 262 in the lower portion of the filter chamber 240. The rims 270 bound an annular filter seat 272, the annular filter seat 272 being centered on the underside of the circular filter chamber lid 216 for alignment with the filter seat 262.

The first and second filter frames 208, 212 are identical in construction. The filter frames 208, 212 comprise a flat annular mating surface 280 including a pair of pin projections 282 and a pair of pin receiving openings 284 evenly spaced about the perimeter of the mating surface 280 so that the pins 282 of the first filter frame can be received in the openings 284 of the second filter frame, and vice versa, so that the mating surfaces 280 of the first and second filter frames 208, 212 can abut in a flush manner.

Referring to the first filter frame 208 for the purpose of describing the construction of the filter frames 208, 212, the first filter frame 208 further comprises a number of ribs 286 depending from the mating surface 280 of the filter frame 208 in a slightly splayed manner, being substantially perpendicular to the plane of the mating surface 280 but canted slightly away from this center line of the filter frame 208. The ribs 286 terminate in an annular base 290. Based 290 comprises an inner annular rim 288 and an annular ring 292 with a raised outer rim 294. The raised outer rim 294, the ring 292 and the rim 288 form a shallow annular cavity 296 for receiving a lower portion of the filter medium 210. Each of the filter frames 208, 212 further comprises an annular recess 298 on a face opposite the mating surface 280, the recess 298 configured to receive annular filter seal 206, 214.

The filter medium 210 is a hollow cylindrical arrangement of a pleated filter paper, the hollow cylinder having a diameter and wall thickness substantially corresponding to the width of the annular ring 292 of the filter frame 208. The filter medium 210 has a height substantially equal to the distance between the annular rings 292 of the first and second filter frames 208, 212 when the frames 208, 212 are assembled with their respective mating surfaces 280 in abutment.

The cyclone separator 200 is assembled by placing the cyclone housing 204 in a sealing engagement with the upper end 230 of the dirt bin 202. The outer wall of the cyclone housing 204 aligns with the outer wall 220 of the dirt bin 202, and the upper end 228 of the central shaft 226 sealing engages the central opening 260 of the cyclone housing 204.

The filter frame is assembled by placing a first filter seal 206 in the annular recess 298 of the first filter frame 208, placing the hollow cylindrical filter medium 210 over the first filter frame 208 so that the lower portion of the filter medium 210 is received in the annular recess 296 of the first filter frame 208, then inserting the second filter frame 212 into the filter medium 210 until the mating surface 280 of the second filter frame 212 abuts the mating surface 280 of the first filter frame 208 in a flush manner. The upper portion of the filter medium 210 is thus received in the annular recess 296 of the second filter frame 212. The second filter seal is then placed in the annular recess 298 of the second filter frame 212.

The filter assembly is then placed into the cyclone housing 204 so that the annular base of the first filter frame 208 is received in the annular filter seat 262 of the cyclone housing 204. The filter chamber lid 216 can then be placed over the filter chamber opening 258 so that the depending rim 268 resides immediately inside the filter chamber wall 242, and the annular base of the second filter frame 212 can be received in the annular filter seat 272 of the filter chamber lid 216 between the rims 270.

The assembled cyclonic separator is now fluidly sealed from the atmosphere except for the inlet opening 254 of the spiral channel 250, and the outlet opening 224 at the base of the dirt bin 202. The inlet opening 254 and outlet opening 224 are fluidly connected through the spiral channel 250 into the interior of the dirt bin 202 and then through the annular inlet section 264 into the filter chamber 240. Any fluid flow must then pass through the filter medium 210 to reach the central opening 260 at the base of the filter chamber 240, from whence it travels through the central shaft 226 to the outlet opening 224.

In a suction cleaner, the suction source is applied to the outlet opening 224, thereby drawing a vacuum throughout the fluid path just described and the inlet opening 254 is then directed by known structures to a surface or object to be cleaned, thereby drawing dirt laden air into the cyclonic separator. The tangential flow through the spiral channel 250 will reduce the velocity in the particles in the air, causing them to fall under gravity into the toroidal dirt chamber of the dirt bin 202. The air flow is further subjected to a severe change in direction as it must flow upwardly through the annular inlet section 264 of the filter chamber 240 before it can pass through the filter medium 210 to the exhaust outlet 224.

While the invention has been specifically described in connection with certain specific embodiments thereof, it is to be understood that this is by way of illustration and not of limitation. Reasonable variation and modification are possible within the forgoing disclosure and drawings without departing from the spirit of the invention which is defined in the appended claims.

What is claimed is:

1. A vacuum cleaner comprising:
a housing defining a cyclonic airflow chamber for separating contaminants from a dirt-containing airstream, said housing further comprising a cyclonic chamber inlet and an airstream outlet in fluid communication with said cyclonic airflow chamber;
a nozzle base including a main suction opening, said main suction opening being fluidly connected with said cyclonic chamber inlet;
an airstream suction source fluidly connected to said main suction opening and to the cyclonic airflow chamber for transporting dirt-containing air from the main suction opening to the cyclonic airflow chamber, said suction source selectively establishing and maintaining a dirt-containing airstream from said main suction opening to said cyclonic chamber inlet;
a main filter assembly including a filter element positioned centrally within said cyclonic airflow chamber for filtering residual contaminants from said dirt-containing airstream prior to exit of said airstream from said cyclonic airflow chamber;
a dirt-collecting bin beneath the main filter assembly within the housing; and
a separator plate between the filter element and the dirt-collecting bin and forming a toroidal chamber within the housing and separating the toroidal chamber from a dirt-collecting chamber.

2. A vacuum cleaner according to claim 1 wherein the separator plate is mounted to a lower portion of the filter element and extends radially from the filter element toward the housing.

3. A vacuum cleaner according to claim 2 wherein the separator plate forms a gap with the housing for passage of dirt particles from the toroidal chamber to the dirtcollecting bin.

4. A vacuum cleaner according to claim 4 wherein the gap between the separator plate and the housing is annular.

5. A vacuum cleaner according to claim 4 wherein the separator plate is circular and the housing has a circular wall adjacent the separator plate.

6. A vacuum cleaner according to claim 2 wherein the separator plate is circular and the housing has a circular wall adjacent the separator plate.

7. A vacuum cleaner according to claim 1 wherein the cyclonic chamber inlet is in the toroidal chamber.

8. A vacuum cleaner according to claim 1 wherein the airstream outlet is in an upper central portion of the housing.

9. A vacuum cleaner according to claim 8, further comprising a secondary filter positioned between the filter element and the airstream outlet.

10. A vacuum cleaner according to claim 9 wherein the secondary filter comprises a fine mesh.

11. A vacuum cleaner according to claim 1, further comprising a secondary filter positioned between the filter element and the airstream outlet.

12. A vacuum cleaner according to claim 1 wherein the secondary filter comprises a fine mesh.

13. A vacuum cleaner according to claim 1 wherein the airstream outlet is in a lower portion of the housing.

14. A vacuum cleaner according to claim 1 wherein the relative cross-sectional area of the separator plate with respect to the housing is in the range of 0.75 to 0.95.

15. A vacuum cleaner according to claim 1 wherein the relative cross-sectional area of the separator plate with respect to the housing is in the range of 0.8 to 0.92.

16. A vacuum cleaner according to claim 1 wherein the relative cross-sectional area of the separator plate with respect to the housing is about 0.9.

17. A vacuum cleaner according to claim 1 wherein the filter element comprises a fine mesh.

18. A vacuum cleaner comprising:
a housing defining a first cyclonic airflow chamber for separating contaminants from a dirt-containing airstream, said housing further comprising an airstream inlet and an airstream outlet in fluid communication with said first cyclonic airflow chamber;
a nozzle base including a main suction opening, said main suction opening being fluidly connected with said airstream inlet;
an airstream suction source fluidly connected to said main suction opening and to the first cyclonic airflow chamber for transporting the dirt-containing airstream from the main suction opening to the first cyclonic airflow chamber, said suction source selectively establishing and maintaining the dirt-containing airstream from said main suction opening to said first cyclonic airflow chamber;
a second cyclonic airflow chamber formed coaxially with the first cyclonic airflow chamber;
a main filter assembly including a filter element positioned between the first and second cyclonic airflow chambers for filtering residual contaminants from said dirt-containing airstream prior to exit of said airstream from said first cyclonic airflow chamber;
a first dirt-collecting bin beneath said first cyclonic airflow chamber; and
a second dirt-collecting bin in communication with the second cyclonic air flow chamber and positioned axially of the first dirt-collecting bin.

19. A vacuum cleaner according to claim 18, further comprising a frustoconical wall defining the second cyclonic airflow chamber and a wall of the second dirtcollecting bin.

20. A vacuum cleaner according to claim 19 wherein the second dirtcollecting bin is positioned axially above the first dirt-collecting bin.

21. A vacuum cleaner according to claim 19 wherein the airstream outlet is positioned in a lower portion of the housing.

22. A vacuum cleaner according to claim 19 wherein the airstream outlet is positioned concentrically with respect to the second cyclonic airflow chamber.

23. A vacuum cleaner according to claim 22 wherein the second dirtcollecting bin is positioned axially above the first dirt-collecting bin.

24. A vacuum cleaner according to claim 22 wherein the airstream outlet is positioned in a lower portion of the housing.

25. A vacuum cleaner according to claim 18 wherein the airstream outlet is positioned concentrically with respect to the second cyclonic airflow chamber.

26. A vacuum cleaner according to claim 25 wherein the second dirtcollecting bin is positioned axially above the first dirt-collecting bin.

27. A vacuum cleaner according to claim 25 wherein the airstream outlet is positioned in a lower portion of the housing.

28. A vacuum cleaner according to claim 18 wherein the filter element is a foraminous wall.

29. A vacuum cleaner according to claim 18 wherein the second dirtcollecting bin is positioned axially above the first dirt-collecting bin.

30. A vacuum cleaner according to claim 18 wherein the airstream outlet is positioned in a lower portion of the housing.

31. A vacuum cleaner according to claim 18, further comprising a separator plate between the first cyclonic airflow chamber and the first dirt-collecting bin.

32. A vacuum cleaner according to claim 31 wherein the relative cross-sectional area of the separator plate with respect to the housing is in the range of 0.75 to 0.95.

33. A vacuum cleaner according to claim 31 wherein the relative cross-sectional area of the separator plate with respect to the housing is in the range of 0.8 to 0.92.

34. A vacuum cleaner according to claim 31 wherein the relative cross-sectional area of the separator plate with respect to the housing is about 0.9.

35. A vacuum cleaner according to claim 18, further comprising at least one vane positioned between the first and second cyclonic airflow chambers for imparting a tangential velocity component to the airflow.

36. A vacuum cleaner comprising:
a housing defining a cyclonic airflow chamber for separating contaminants from a dirt-containing airstream, said housing further comprising an airstream inlet and an airstream outlet in fluid communication with said cyclonic airflow chamber;
a nozzle base including a main suction opening, said main suction opening being fluidly connected with said airstream inlet;
an airstream suction source fluidly connected to said main suction opening and to the cyclonic airflow chamber for transporting the dirt-containing airstream from the main suction opening to the cyclonic airflow chamber, said suction source selectively establishing and maintaining the dirt-containing airstream from said main suction opening to said airstream inlet;
a main filter assembly including a filter element for filtering residual contaminants from said suction airstream; and
a dirt-collecting bin beneath the cyclonic airflow chamber within the housing,
wherein the cyclonic airflow chamber is formed by a tangential helical ramp.

37. A vacuum cleaner according to claim 36 wherein the main filter assembly is concentric with the cyclonic airflow chamber.

38. A vacuum cleaner according to claim 36, further comprising an opening from the cyclonic airflow chamber into the dirt-collecting bin and an opening from the dirt-collecting bin into the main filter assembly, whereby the dirt-containing airstream changes direction to enter the main filter assembly.

39. A vacuum cleaner according to claim 36 wherein the airstream outlet is centrally located within the housing.

40. A vacuum cleaner according to claim 36 wherein the airstream outlet passes through the dirt-collecting bin.
